(19) United States
(12) Patent Application Publication
(10) Pub. No.: US 2024/0150240 A1
(43) Pub. Date: May 9, 2024

(54) COAL-CERAMIC SYNTHETIC AGGREGATE

(71) Applicants: Arnold HILL, Oviedo, FL (US); Walter SHERWOOD, Oviedo, FL (US); William EASTER, Oviedo, FL (US)

(72) Inventors: Arnold HILL, Oviedo, FL (US); Walter SHERWOOD, Oviedo, FL (US); William EASTER, Oviedo, FL (US)

(21) Appl. No.: 18/549,003

(22) PCT Filed: Apr. 26, 2022
(86) PCT No.: PCT/US2022/026347

§ 371 Date: Sep. 5, 2023

Related U.S. Application Data
(60) Provisional application No. 63/156,514, filed on Mar. 4, 2021.

(51) Int. Cl. C04B 20/10; C04B 14/02; C04B 18/02; C04B 18/08; C04B 28/04

(52) U.S. Cl. CPC C04B 20/1055; C04B 14/022; C04B 18/021; C04B 18/08; C04B 28/04; C04B 2201/20; C04B 2201/50

(57) ABSTRACT

Synthetic aggregate that includes a plurality of agglomerations. Each of the plurality of agglomerations may include a core; and a shell material disposed on the core. According to various embodiments, the construction aggregate may be non-flammable. According to various embodiments, at least one agglomeration of the plurality of agglomerations may have a plurality of cores. The core may include coal, a coal byproduct, and combinations thereof. According to various embodiments, the coal may be a type such as lignite, sub-bituminous, bituminous, and anthracite. The coal byproduct may be fly ash, bottom ash, shale coal, or coal gob.

### BRIEF DESCRIPTION OF THE FIGURES

Many aspects of this disclosure can be better understood with reference to the following figures.

FIG. 1 is an example according to various embodiments, illustrating the compressive strength of bricks and blocks comprising construction aggregates according to various embodiments in comparison to conventional bricks and blocks.

FIG. 2 is an example according to various embodiments, illustrating the flexure strength of bricks and blocks comprising construction aggregates according to various embodiments in comparison to conventional bricks and blocks.

FIG. 3 is an example according to various embodiments, illustrating the density of tiles, bricks, and blocks comprising construction aggregates according to various embodiments in comparison to conventional bricks and blocks.

FIG. 4 is an example according to various embodiments, illustrating three concrete cylinders comprising construction aggregates according to various embodiments.

It should be understood that the various embodiments are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the term “standard temperature and pressure” generally refers to 25° C. and 1 atmosphere. Standard temperature and pressure may also be referred to as “ambient conditions.” Unless indicated otherwise, parts are by weight, temperature is in ° C., and pressure is at or near atmospheric. The terms “elevated temperatures” or “high-temperatures” generally refer to temperatures of at least 100° C.

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

As used herein, the term “construction aggregate” or “aggregate” refers generally to a broad category of coarse- to medium-grained particulate material used in construction, including sand, gravel, crushed stone, slag, recycled concrete and geosynthetic aggregates. Various embodiments provide novel construction aggregates which may be used in place of conventional construction aggregates. The synthetic aggregates according to various embodiments may be used as construction aggregates.

As used herein, the term “agglomeration” refers to a mass or collection of things. According to various embodiments, an agglomeration may comprise a single core and a single shell, a plurality of cores and a single shell around one or more of the cores, or any combination of cores and shells grouped, amassed, or adhered together.

As used herein, the term “average size” refers to the particle size. The particle size of a spherical object can be unambiguously and quantitatively defined by its diameter. However, a typical material object is likely to be irregular in shape and non-spherical. There are several ways of extending the above quantitative definition to apply to non-spherical particles. Existing definitions are based on replacing a given particle with an imaginary sphere that has one of the properties identical with the particle. Volume-based particle size equals the diameter of the sphere that has the same volume as a given particle. Area-based particle size equals the diameter of the sphere that has the same surface area as a given particle. Weight-based particle size equals the diameter of the sphere that has the same weight as a given particle. Hydrodynamic or aerodynamic particle size equals the diameter of the sphere that has the same drag coefficient as a given particle.

As used herein, the term “cement” has its ordinary meaning in the field of construction materials. A cement is a binder, a substance used for construction that sets, hardens, and adheres to other materials to bind them together. Cement is seldom used on its own, but rather to bind sand and gravel (aggregate) together. Cement mixed with fine aggregate produces mortar for masonry, or with sand and gravel, produces conventional concrete. Conventional concrete is the most widely used material in existence and is behind only water as the planet's most-consumed resource. Cements used in construction are usually inorganic, often lime or calcium silicate based, which can be characterized as non-hydraulic or hydraulic respectively, depending on the ability of the cement to set in the presence of water (see hydraulic and non-hydraulic lime plaster). Non-hydraulic cement does not set in wet conditions or under water. Rather, it sets as it dries and reacts with carbon dioxide in the air. It is resistant to attack by chemicals after setting. Hydraulic cements (e.g., Portland cement) set and become adhesive due to a chemical reaction between the dry ingredients and water.

As used herein, the term “concrete” may refer to conventional concrete as described above and/or to novel concrete comprising construction aggregates according to various embodiments.

A variety of standardized test methods have been defined for international use. The standard test method for determining the bulk density of aggregates is given in ASTM C 29 (AASHTO T 19). The standard test method for determining the combustibility or flammability of materials is ASTM E136. The standard test for determining the compressive strength of cylindrical concrete specimens is ASMT C39/C39M-20. The standard test method for determining the flexural strength of concrete is ASTM C78/C78M-18. The standard test method for determining the density, yield, and air content of concrete is ASTM C138/C138M-17a. Unless otherwise specified, all measurements were performed using the relevant standardized test method.

As used herein, the term “coal” has its ordinary meaning, referring to a combustible black or brownish-black sedimentary rock, formed as rock strata called coal seams. Coal is mostly carbon with variable amounts of other elements; chiefly hydrogen, sulfur, oxygen, and nitrogen. Coal is formed when dead plant matter decays into peat and is converted into coal by the heat and pressure of deep burial over millions of years.

As used herein, the term “lignite” or “brown coal” refers to a soft, brown, combustible, sedimentary rock formed from naturally compressed peat. It is considered the lowest rank of coal due to its relatively low heat content. It has a carbon content around 25 to 35 percent.

As used herein, the term “sub-bituminous” refers to a type of lower grade coal which contains 35%-45% carbon. The properties of this type are between those of lignite, the lowest grade coal, and those of bituminous coal, the second highest grade of coal.

As used herein, the term “bituminous” or “black coal” refers to a relatively soft coal containing a tarlike substance called bitumen or asphalt. It is of higher quality than lignite and Sub-bituminous coal, but of poorer quality than anthracite. Formation is usually the result of high pressure being exerted on lignite. Its coloration can be black or sometimes dark brown; often there are well-defined bands of bright and dull material within the seams.

As used herein, the term “anthracite” or “hard coal” refers to a hard, compact variety of coal that has a submetallic luster. It has the highest carbon content, the fewest impurities, and the highest energy density of all types of coal and is the highest ranking of coals. Anthracite is the most metamorphosed type of coal (but still represents low-grade metamorphism), in which the carbon content is between 86% and 98%. The term is applied to those varieties of coal which do not give off tarry or other hydrocarbon vapors when heated below their point of ignition.

As used herein, the term “coal byproduct” refers to coal combustion products and/or products of coal production methods, such as coal refuse. Examples of coal refuse (also described as coal waste, coal tailings, waste material, culm, boney, or gob) is the material left over from coal mining, usually as tailings piles or spoil tips.

As used herein, the term “fly ash” or “flue ash” refers to a coal combustion product that is composed of the particulates (fine particles of burned fuel) that are driven out of coal-fired boilers together with the flue gases.

As used herein, the term “bottom ash” refers to a coal combustion product, specifically ash that falls to the bottom of a boiler's combustion chamber. Bottom ash is part of the non-combustible residue of combustion in a power plant, boiler, furnace or incinerator.

As used herein, the term “shale coal” refers to a coal waste product. Shale coal usually refers to a type of coal refuse that is a mixture of mostly shale with some coal, but usually not enough coal to make it economical to burn or separate out the coal.

As used herein, the term “coal gob” refers to a coal waste product. GOB is also coal refuse that is a mixture of mostly rock, dirt, and sometimes clay and some coal, again typically considered not to be worth burning or separating.

As used herein, the term “mixing” refers to a unit operation in industrial process engineering that involves manipulation of a heterogeneous physical system with the intent to make it more homogeneous. Mixing is performed to allow heat and/or mass transfer to occur between one or more streams, components or phases.

As used herein, the term “pyrolysis” or “pyrolyzing” refers to a process of thermal decomposition of materials at elevated temperatures in an inert atmosphere. It involves a change of chemical composition.

As used herein, the term “inert gas” refers to a gas that does not undergo chemical reactions under a set of given conditions. The noble gases often do not react with many substances and were historically referred to as the inert gases. Purified argon and nitrogen gases are most commonly used as inert gases due to their high natural abundance (78.3% N₂, 1% Ar in air) and low relative cost.

As used herein, the term “disposed on” refers to a positional state indicating that one object or material is arranged in a position adjacent to the position of another object or material. The term does not require or exclude the presence of intervening objects, materials, or layers.

As used herein, the term “core-shell arrangement” refers to a positional state of two components, a core and a shell. In a core-shell arrangement, the shell is disposed on the core so as to at least partially surround the core.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by prior disclosure. Further, the dates of publication provided could be different from the actual publication dates that may need to be independently confirmed.

### General Discussion

Various embodiments relate to a synthetic aggregate that may include a plurality of agglomerations. Each of the plurality of agglomerations may include a core; and a shell material disposed on the core. According to various embodiments, the construction aggregate may be non-flammable. According to various embodiments, at least one agglomeration of the plurality of agglomerations may have a plurality of cores.

The core may include coal, a coal byproduct, and combinations thereof. According to various embodiments, the coal may be a type such as lignite, sub-bituminous, bituminous, and anthracite. The coal byproduct may be fly ash, bottom ash, shale coal, or coal gob.

The shell material may include a polymer-derived ceramic material. According to various embodiments, the polymer-derived ceramic material may derived from a precursor such as silicon oxycarbide (SiOC); silicon carbide with high oxygen (SiCO); silicon carbide (SiC); Silicon nitride (Si₃N₄); Silicon carbonitride (SiCN). The PDC type dramatically affects cost, with the SiOC precursors being by far the lowest cost and most versatile. The type of PDC derived ceramic affects the hardness, density and strength of the ceramic aggregate. The preferred precursor from a cost/performance basis is SiOC.

According to various embodiments, according to various embodiments the initial particle size of the coal and/or coal byproducts may be from about 100 nanometers to about 100 micrometers, or from about 100 nanometers to about 10 micrometers. Each range described herein is intended to include all numerical values encompassed by the range. Furthermore, additional ranges may be formed from any lower limits and/or upper limits described herein. For example, according to various embodiments the initial particle size of the coal and/or coal byproducts may be within a range having a lower limit and/or an upper limit. The range may include or exclude the lower limit and/or the upper limit. By way of example and not limitation, a lower limit and/or an upper limit may be selected from 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000 and 100000 nanometers. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, according to various embodiments the initial particle size of the coal and/or coal byproducts may be of: about 10 to about 100000 nanometers, less than about 10 nanometers, greater than about 10 nanometers, less than about 100000 nanometers, or greater than about 100000 nanometers, etc. All such ranges are contemplated and are intended to be explicitly disclosed and recited. Each value recited is intended to be modified by the term “about.”

According to various embodiments, according to various embodiments, the core material may represent an amount of the construction aggregate in a range of up to about 70% by weight. Each range described herein is intended to include all numerical values encompassed by the range. Furthermore, additional ranges may be formed from any lower limits and/or upper limits described herein. For example, according to various embodiments, the core material may represent an amount of the construction aggregate within a range having a lower limit and/or an upper limit. The range may include or exclude the lower limit and/or the upper limit. By way of example and not limitation, a lower limit and/or an upper limit may be selected from 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 and 80% by weight. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, according to various embodiments, the core material may represent an amount of the construction aggregate of: about 0 to about 80% by weight, less than about 0% by weight, greater than about 0% by weight, less than about 80% by weight, or greater than about 80% by weight, etc. All such ranges are contemplated and are intended to be explicitly disclosed and recited. Each value recited is intended to be modified by the term “about.”

According to various embodiments, the plurality of agglomerations may have an average size of from about 0.1 micrometers to about 5 millimeters. Each range described herein is intended to include all numerical values encompassed by the range. Furthermore, additional ranges may be formed from any lower limits and/or upper limits described herein. For example, the plurality of agglomerations may have an average size within a range having a lower limit and/or an upper limit. The range may include or exclude the lower limit and/or the upper limit. By way of example and not limitation, a lower limit and/or an upper limit may be selected from 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 2, 3, 4, 5, 6, 7, 8, 9 and 10 millimeters. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the plurality of agglomerations may have an average size of: about 0.05 to about 10 millimeters, less than about 0.05 millimeters, greater than about 0.05 millimeters, less than about 10 millimeters, or greater than about 10 millimeters, etc. All such ranges are contemplated and are intended to be explicitly disclosed and recited. Each value recited is intended to be modified by the term “about.”

According to various embodiments, the construction aggregate may have a density of from about 1.57 g/cc to about 1.95 g/cc. Each range described herein is intended to include all numerical values encompassed by the range. Furthermore, additional ranges may be formed from any lower limits and/or upper limits described herein. For example, the construction aggregate may have a density within a range having a lower limit and/or an upper limit. The range may include or exclude the lower limit and/or the upper limit. By way of example and not limitation, a lower limit and/or an upper limit may be selected from 1.25, 1.26, 1.27, 1.28, 1.29, 1.3, 1.31, 1.32, 1.33, 1.34, 1.35, 1.36, 1.37, 1.38, 1.39, 1.4, 1.41, 1.42, 1.43, 1.44, 1.45, 1.46, 1.47, 1.48, 1.49, 1.5, 1.51, 1.52, 1.53, 1.54, 1.55, 1.56, 1.57, 1.58, 1.59, 1.6, 1.61, 1.62, 1.63, 1.64, 1.65, 1.66, 1.67, 1.68, 1.69, 1.7, 1.71, 1.72, 1.73, 1.74, 1.75, 1.76, 1.77, 1.78, 1.79, 1.8, 1.81, 1.82, 1.83, 1.84, 1.85, 1.86, 1.87, 1.88, 1.89, 1.9, 1.91, 1.92, 1.93, 1.94, 1.95, 1.96, 1.97, 1.98, 1.99, 2, 2.01, 2.02, 2.03, 2.04, 2.05, 2.06, 2.07, 2.08, 2.09, 2.1, 2.11, 2.12, 2.13, 2.14 and 2.15 g/cc. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the construction aggregate may have a density of: about 1.25 to about 2.15 g/cc, less than about 1.25 g/cc, greater than about 1.25 g/cc, less than about 2.15 g/cc, or greater than about 2.15 g/cc, etc. All such ranges are contemplated and are intended to be explicitly disclosed and recited. Each value recited is intended to be modified by the term “about.”

According to various embodiments, the silicon oxycarbide may be a high-oxygen silicon carbide (SiCO), comprising at least 20% oxygen by weight.

According to various embodiments, the composition for SiOC may be Si(x)C(y)O(z) with x+y+z=1. By way of example, these materials can range from Si(0.1)C(0.8)O(0.1) for high carbon materials to Si(0.4)C(0.1)O(0.5). According to various embodiments, in the formula Si(x)C(y)O(z), with the proviso that x+y+z=1, any of x, y, or z may be in a range of from 0.1 to 0.9. Each range described herein is intended to include all numerical values encompassed by the range. Furthermore, additional ranges may be formed from any lower limits and/or upper limits described herein. For example, in the formula Si(x)C(y)O(z), with the proviso that x+y+z=1, any of x, y, or z may be in a range within a range having a lower limit and/or an upper limit. The range may include or exclude the lower limit and/or the upper limit. By way of example and not limitation, a lower limit and/or an upper limit may be selected from 0.025, 0.05, 0.075, 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875, 0.9, 0.925, 0.95 and 0.975. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, in the formula Si(x)C(y)O(z), with the proviso that x+y+z=1, any of x, y, or z may be in a range of: about 0.025 to about 0.975, less than about 0.025, greater than about 0.025, less than about 0.975, or greater than about 0.975, etc. All such ranges are contemplated and are intended to be explicitly disclosed and recited. Each value recited is intended to be modified by the term “about.”

Various embodiments relate to a concrete that may include a first synthetic aggregate and optionally additional synthetic aggregates, such as, a second synthetic aggregate. Any of the synthetic aggregates described according to the various embodiments may be used. The first synthetic aggregate and the second synthetic aggregate may differ at least in the average particle size of the plurality of agglomerations contained therein.

According to various embodiments, the plurality of agglomerations of the first synthetic aggregate, the second synthetic aggregate, and/or any additional synthetic aggregates may have average sizes that are the same or different. For example, according to an embodiment, the first synthetic aggregate may have an average size of from about 500 to about 100 micrometers and the second synthetic aggregate may have an average size less than about 500 micrometers. According to various embodiments, the average size of the synthetic aggregates may be in a range of from about 0.1 micrometers to about 1000 micrometers. Each range described herein is intended to include all numerical values encompassed by the range. Furthermore, additional ranges may be formed from any lower limits and/or upper limits described herein. For example, the average size of the synthetic aggregates may be in a range within a range having a lower limit and/or an upper limit. The range may include or exclude the lower limit and/or the upper limit. By way of example and not limitation, a lower limit and/or an upper limit may be selected from 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900 and 1000 micrometers. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the average size of the synthetic aggregates may be in a range of: about 0.1 to about 1000 micrometers, less than about 0.1 micrometers, greater than about 0.1 micrometers, less than about 1000 micrometers, or greater than about 1000 micrometers, etc. All such ranges are contemplated and are intended to be explicitly disclosed and recited. Each value recited is intended to be modified by the term “about.”

According to various embodiments, the concrete may exhibit a compressive strength of from about 3000 to about 7500 psi. Each range described herein is intended to include all numerical values encompassed by the range. Furthermore, additional ranges may be formed from any lower limits and/or upper limits described herein. For example, the concrete may exhibit a compressive strength within a range having a lower limit and/or an upper limit. The range may include or exclude the lower limit and/or the upper limit. By way of example and not limitation, a lower limit and/or an upper limit may be selected from 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, 9100, 9200, 9300, 9400, 9500, 9600, 9700, 9800, 9900 and 10000 psi. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the concrete may exhibit a compressive strength of: about 1000 to about 10000 psi, less than about 1000 psi, greater than about 1000 psi, less than about 10000 psi, or greater than about 10000 psi, etc. All such ranges are contemplated and are intended to be explicitly disclosed and recited. Each value recited is intended to be modified by the term “about.”

According to various embodiments, the concrete may exhibit a flexural strength of from about 500 psi to about 2000 psi. Each range described herein is intended to include all numerical values encompassed by the range. Furthermore, additional ranges may be formed from any lower limits and/or upper limits described herein. For example, the concrete may exhibit a flexural strength within a range having a lower limit and/or an upper limit. The range may include or exclude the lower limit and/or the upper limit. By way of example and not limitation, a lower limit and/or an upper limit may be selected from 10, 20, 30, 40, 50, 60, 70, 80, 90, 100, 200, 300, 400, 500, 600, 700, 800, 900, 1000, 1500, 2000, 2500, 3000, 3500, 4000, 4500, 5000, 5500, 6000, 6500, 7000, 7500, 8000, 8500, 9000, 9500 and 10000 psi. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the concrete may exhibit a flexural strength of: about 10 to about 10000 psi, less than about 10 psi, greater than about 10 psi, less than about 10000 psi, or greater than about 10000 psi, etc. All such ranges are contemplated and are intended to be explicitly disclosed and recited. Each value recited is intended to be modified by the term “about.”

According to various embodiments, the concrete may exhibit a density of from about 1.3 g/cc to about 2.4 g/cc. Each range described herein is intended to include all numerical values encompassed by the range. Furthermore, additional ranges may be formed from any lower limits and/or upper limits described herein. For example, the concrete may exhibit a density within a range having a lower limit and/or an upper limit. The range may include or exclude the lower limit and/or the upper limit. By way of example and not limitation, a lower limit and/or an upper limit may be selected from 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9 and 5 g/cc. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the concrete may exhibit a density of: about 0.5 to about 5 g/cc, less than about 0.5 g/cc, greater than about 0.5 g/cc, less than about 5 g/cc, or greater than about 5 g/cc, etc. All such ranges are contemplated and are intended to be explicitly disclosed and recited. Each value recited is intended to be modified by the term “about.”

As stated above, a concrete according to various embodiments may include a first synthetic aggregate and a second synthetic aggregate. The first synthetic aggregate may have an average size of from about 500 to about 100 micrometers and the second synthetic aggregate may have an average size less than about 500 micrometers. The concrete may include the first synthetic aggregate in an amount of from about 50% to about 85% by weight. Each range described herein is intended to include all numerical values encompassed by the range. Furthermore, additional ranges may be formed from any lower limits and/or upper limits described herein. For example, the concrete may include the first synthetic aggregate in an amount within a range having a lower limit and/or an upper limit. The range may include or exclude the lower limit and/or the upper limit. By way of example and not limitation, a lower limit and/or an upper limit may be selected from 10, 15, 20, 25, 30, 35, 40, 45, 50, 55, 60, 65, 70, 75, 80, 85, 90 and 95% by weight. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the concrete may include the first synthetic aggregate in an amount of: about 20 to about 95% by weight, less than about 20% by weight, greater than about 20% by weight, less than about 95% by weight, or greater than about 95% by weight, etc. All such ranges are contemplated and are intended to be explicitly disclosed and recited. Each value recited is intended to be modified by the term “about.” According to various embodiments, the concrete may include the second synthetic aggregate in an amount of from about 15% to about 50% by weight. Each range described herein is intended to include all numerical values encompassed by the range. Furthermore, additional ranges may be formed from any lower limits and/or upper limits described herein. For example, the concrete may include the second synthetic aggregate in an amount within a range having a lower limit and/or an upper limit. The range may include or exclude the lower limit and/or the upper limit. By way of example and not limitation, a lower limit and/or an upper limit may be selected from 10, 15, 20, 25, 30, 35, 40, 45, 50, 55, 60, 65, 70, 75, 80, 85, 90 and 95% by weight. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the concrete may include the second synthetic aggregate in an amount of: about 10 to about 95% by weight, less than about 10% by weight, greater than about 10% by weight, less than about 95% by weight, or greater than about 95% by weight, etc. All such ranges are contemplated and are intended to be explicitly disclosed and recited. Each value recited is intended to be modified by the term “about.”

According to various embodiments, the concrete may include a cement material in an amount of from about 30% to about 60% by weight. Each range described herein is intended to include all numerical values encompassed by the range. Furthermore, additional ranges may be formed from any lower limits and/or upper limits described herein. For example, the concrete may include a cement material in an amount within a range having a lower limit and/or an upper limit. The range may include or exclude the lower limit and/or the upper limit. By way of example and not limitation, a lower limit and/or an upper limit may be selected from 5, 10, 15, 20, 25, 30, 35, 40, 45, 50, 55, 60, 65, 70, 75, 80, 85 and 90% by weight. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the concrete may include a cement material in an amount of: about 5 to about 90% by weight, less than about 5% by weight, greater than about 5% by weight, less than about 90% by weight, or greater than about 90% by weight, etc. All such ranges are contemplated and are intended to be explicitly disclosed and recited. Each value recited is intended to be modified by the term “about.”

Various embodiments relate to a method including mixing a plurality of core material particles with a polymer-derived ceramic precursor material and optionally a catalyst to form a mixture, heating the mixture to a curing temperature for a curing time to form a cured mixture; pyrolyzing the cured mixture in the presence of an inert gas at a pyrolysis temperature for a pyrolysis time to produce a plurality of agglomerations; and optionally milling and sieving the plurality of agglomerations to have an average size to produce a construction aggregate. The construction aggregate may correspond to any synthetic aggregate according to the various embodiments described herein. According to various embodiments, the method may further include mixing the construction aggregate with a cement or a cement material to form a concrete.

According to various embodiments, the polymer-derived ceramic precursor material, such as a SiOC precursor, can be cured by any of three methods: catalyzed thermal cure, uncatalyzed thermal cure, or catalyzed room temperature cure. Generally, catalyzed thermal cure may employ two types of catalysts: (1) Platinum based such as Ashby's catalyst or Karstedt's catalyst, which are a group of catalysts based on platinum complexes in divinyl or tetravinyl siloxanes, these can work at room temperature as well as with heating (heating accelerates the cure); and (2) Organic peroxide catalysts (or initiators) such as Luperox 101, or Dicumyl Peroxide, these require heating to above 90° C. to activate. Room Temperature/moisture curing may include catalysts that are typically metal complexes or metallorganic compounds. Examples are Dibutyltin dilaurate, dibutyltin diacetate, Zinc octoate, and other organo-zinc compounds these work slowly (over 1-5 days) but can work at room temperature, going above 100° C. inactivates the catalyst.

The plurality of agglomerations may correspond to the agglomerations according to any of the various embodiments described herein. For example, the plurality of agglomerations may include a core; and a shell material disposed on the core. The core may include at least one core material particle. The shell material may include a polymer-derived ceramic material derived from the polymer-derived ceramic precursor material, according to any of the embodiments described herein.

According to various embodiments, each of the plurality of core material particles may include coal, a coal byproduct, and combinations thereof. As in other embodiments, the coal may be a type such as lignite, sub-bituminous, bituminous, and anthracite. Similarly, the coal byproduct may be fly ash, bottom ash, shale coal, and coal gob.

The average size after milling and sieving the plurality of agglomerations may be in a range of from about 0.1 micrometers to about 5 millimeters, as described with respect to other embodiments. The construction aggregate may have a density of from about 1.57 g/cc to about 1.95 g/cc, as described in other embodiments.

According to various embodiments, the curing temperature may be from about 20 degrees Celsius to about 200 degrees Celsius. Each range described herein is intended to include all numerical values encompassed by the range. Furthermore, additional ranges may be formed from any lower limits and/or upper limits described herein. For example, the curing temperature may be within a range having a lower limit and/or an upper limit. The range may include or exclude the lower limit and/or the upper limit. By way of example and not limitation, a lower limit and/or an upper limit may be selected from 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245 and 250 degrees Celsius. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the curing temperature may be of: about 15 to about 250 degrees Celsius, less than about 15 degrees Celsius, greater than about 15 degrees Celsius, less than about 250 degrees Celsius, or greater than about 250 degrees Celsius, etc. All such ranges are contemplated and are intended to be explicitly disclosed and recited. Each value recited is intended to be modified by the term “about.”

According to various embodiments, the curing time may be from about 1 to about 3 hours. Each range described herein is intended to include all numerical values encompassed by the range. Furthermore, additional ranges may be formed from any lower limits and/or upper limits described herein. For example, the curing time may be within a range having a lower limit and/or an upper limit. The range may include or exclude the lower limit and/or the upper limit. By way of example and not limitation, a lower limit and/or an upper limit may be selected from 0.25, 0.5, 0.75, 1, 1.25, 1.5, 1.75, 2, 2.25, 2.5, 2.75, 3, 3.25, 3.5, 3.75, 4, 4.25, 4.5, 4.75, 5, 10, 15, 20, 25, 30, 35, 40, 45 and 50 hours. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the curing time may be of: about 0.25 to about 50 hours, less than about 0.25 hours, greater than about 0.25 hours, less than about 50 hours, or greater than about 50 hours, etc. All such ranges are contemplated and are intended to be explicitly disclosed and recited. Each value recited is intended to be modified by the term “about.”

According to various embodiments, the pyrolysis temperature may be from about 700 degrees Celsius to about 1200 degrees Celsius. Each range described herein is intended to include all numerical values encompassed by the range. Furthermore, additional ranges may be formed from any lower limits and/or upper limits described herein. For example, the pyrolysis temperature may be within a range having a lower limit and/or an upper limit. The range may include or exclude the lower limit and/or the upper limit. By way of example and not limitation, a lower limit and/or an upper limit may be selected from 200, 250, 300, 350, 400, 450, 500, 550, 600, 650, 700, 750, 800, 850, 900, 950, 1000, 1050, 1100, 1150, 1200, 1250, 1300, 1350, 1400, 1450 and 1500 degrees Celsius. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the pyrolysis temperature may be of: about 200 to about 1500 degrees Celsius, less than about 200 degrees Celsius, greater than about 200 degrees Celsius, less than about 1500 degrees Celsius, or greater than about 1500 degrees Celsius, etc. All such ranges are contemplated and are intended to be explicitly disclosed and recited. Each value recited is intended to be modified by the term “about.”

According to various embodiments, the pyrolysis time may be from about 3 to about 5 hours. Each range described herein is intended to include all numerical values encompassed by the range. Furthermore, additional ranges may be formed from any lower limits and/or upper limits described herein. For example, the pyrolysis time may be within a range having a lower limit and/or an upper limit. The range may include or exclude the lower limit and/or the upper limit. By way of example and not limitation, a lower limit and/or an upper limit may be selected from 0.25, 0.5, 0.75, 1, 1.25, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, 9.75, 10, 20, 30, 40 and 50 hours. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, the pyrolysis time may be of: about 0.25 to about 50 hours, less than about 0.25 hours, greater than about 0.25 hours, less than about 50 hours, or greater than about 50 hours, etc. All such ranges are contemplated and are intended to be explicitly disclosed and recited. Each value recited is intended to be modified by the term “about.”

According to various embodiments, the method may include controlling a property of the synthetic aggregate. The property may be, for example, one or more of the density, the hardness, and the strength of the synthetic aggregate. The property of the synthetic aggregate may be controlled by adjusting the ratio of the core material particles, such as coal and coal byproducts, to the polymer-derived ceramic precursor material in the initial mixture.

According to various embodiments, according to various embodiments the method may including mixing the plurality of core material particles in an amount of from about 1% to about 99% by weight based on the total weight of the mixture. Each range described herein is intended to include all numerical values encompassed by the range. Furthermore, additional ranges may be formed from any lower limits and/or upper limits described herein. For example, according to various embodiments the method may including mixing the plurality of core material particles in an amount within a range having a lower limit and/or an upper limit. The range may include or exclude the lower limit and/or the upper limit. By way of example and not limitation, a lower limit and/or an upper limit may be selected from 0.5, 1, 5, 10, 15, 20, 25, 30, 35, 40, 45, 50, 55, 60, 65, 70, 75, 80, 85, 90 and 99% by weight. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, according to various embodiments the method may including mixing the plurality of core material particles in an amount of: about 0.5 to about 99% by weight, less than about 0.5% by weight, greater than about 0.5% by weight, less than about 99% by weight, or greater than about 99% by weight, etc. All such ranges are contemplated and are intended to be explicitly disclosed and recited. Each value recited is intended to be modified by the term “about.”

According to various embodiments, according to various embodiments the method may including mixing the polymer-derived ceramic precursor material in an amount of from about 1% to about 99% by weight based on the total weight of the mixture. Each range described herein is intended to include all numerical values encompassed by the range. Furthermore, additional ranges may be formed from any lower limits and/or upper limits described herein. For example, according to various embodiments the method may including mixing the polymer-derived ceramic precursor material in an amount within a range having a lower limit and/or an upper limit. The range may include or exclude the lower limit and/or the upper limit. By way of example and not limitation, a lower limit and/or an upper limit may be selected from 0.5, 1, 5, 10, 15, 20, 25, 30, 35, 40, 45, 50, 55, 60, 65, 70, 75, 80, 85, 90 and 99% by weight. A range formed from a single lower limit includes at least the lower limit and all numerical values greater than the lower limit regardless of whether the values are explicitly recited in this disclosure. A range formed from a single upper limit includes at least the upper limit and all numerical values less than the upper limit regardless of whether the values are explicitly recited in this disclosure. A range formed from a combination of a lower limit and an upper limit includes at least the lower limit, the upper limit, and all numerical values therebetween regardless of whether the values are explicitly recited in this disclosure. For example, based on the set of exemplary upper limits and lower limits explicitly recited above, according to various embodiments the method may including mixing the polymer-derived ceramic precursor material in an amount of: about 0.5 to about 99% by weight, less than about 0.5% by weight, greater than about 0.5% by weight, less than about 99% by weight, or greater than about 99% by weight, etc. All such ranges are contemplated and are intended to be explicitly disclosed and recited. Each value recited is intended to be modified by the term “about.”

Various embodiments relate to a range of synthetic aggregate materials. The synthetic aggregate materials may be suitable as construction aggregates. The aggregate materials may include a plurality of agglomerations. Each of the agglomerations may be collections of one or more bonded particles. The agglomerations may include powdered coal or coal byproducts and ceramic materials that bond the particles together and seal them within the ceramic. The ceramic material may typically be formed by the pyrolysis of a polymer-derived ceramic (PDC) precursor resin. The coal and/or other related particles may be mixed and coated with the PDC resin by various methods. The resins are premixed with a suitable catalyst that allows the coal/resin mixture to harden when subjected to heating. The resin may then be cured at a curing temperature for a curing time. According to some embodiments, the curing temperature may be above 65° C. and below 200° C. and the curing temperature may be up to about 2 hours. After curing, the material may be “pyrolyzed” in an inert gas furnace at a pyrolysis temperature for a pyrolysis time. The pyrolysis temperature may be from about 700° C. to about 1200° C. and the pyrolysis temperature may be up to about 4 hours to produce the ceramic coated aggregate material. This carbon/ceramic material is then milled down and sieved to specific sizes ranging from <1 micron up to 5 millimeters or larger. The milled aggregate is sized using conventional sieving processes. This milled and sized material is what constitutes the aggregate which can be directly added to construction materials such as concrete mixtures, plastics, engineering resins, or PDC precursor resins.

According to various embodiments, the particles such as coal or fly ash are encapsulated in ceramic and bonded together by the ceramic prior to use in the application such as an aggregate for high strength, low density concrete. This encapsulation may prevent unwanted elements present in coal byproducts from leaching out into the environment.

The synthetic aggregates according to various embodiments have a number of advantages. The synthetic aggregates according to various embodiments may have a lower density (˜1.57 g/cc to 1.95 g/cc) than most other low cost aggregates such as sand (2.2 to 2.8 g/cc) granite (2.69 g/cc), as well as all commonly used plastic fillers such as talc and calcium carbonate (2.7/g/cc), or mica (2.8 g/cc). The coal-based synthetic aggregates according to various embodiments may handle up to 400° C. for long times, flyash and shale coal-based aggregates can be used at up to 1100° C. The temperature limit is due to the possibility that some of the ceramic coating on the coal particles may be removed or damaged. The coal particles may oxidize slowly when exposed to air at 400° C. and above. The ceramic coating, according to various embodiments, can withstand air up to 1400° C. so as long as the coating is intact. When the coating is intact, the particles will be protected and the material retains its properties. It is possible to envision a scenario where drilling or cutting a roof tile made with a coal based aggregate according to various embodiments might expose some of the cut surface coal particles to the air. This has been confirmed by taking cut bars and heating them for 24 hours at 400° C. in air and the resulting mass loss tracks with the calculated coal content.

The synthetic aggregates according to various embodiments may be electrically conductive and may be magnetic if made from some types of fly ash. Fly ash and bottom ash contain many types of metal oxides, a number of these oxides will be attracted to a magnet (are Ferrimagnetic). Many fly ash types have been shown by chemical analysis to contain metal oxides such as magnetite (Fe₃O₄) Nickel oxide, yttrium-iron oxides and barium-iron oxides. The presence of these oxides has been shown to render materials formed form PDC ceramic coated fly ash able to be attracted by a standard magnet. According to various embodiments, these properties may be imparted to whatever material that uses fly ash aggregate as filler.

Coal-based synthetic aggregates according to various embodiments, having up to 70% coal, are not flammable, will not burn, or support combustion. In this case UL94 testing was employed, which applies to resin based composite materials and involves multiple 10 second duration direct exposures to a 1400° C. flame. The material did not support a flame and was classified as V-0 which for purposes of the present disclosure is considered to be not flammable.

The synthetic aggregates according to various embodiments are not affected by most acids, bases, or organic chemicals unlike many other fillers. A person having ordinary skill in the art would have multiple ways to confirm this chemical resistance directly. The polymer-derived ceramics employed according to various embodiments may be resistant to nearly all acids (with the possible exception of hydrofluoric acid) bases up to pH 10 and all solvents. High purity carbon, which is what the coal becomes during pyrolysis is also resistant to all acids, bases, and chemicals, therefore, the ceramic coated coal according to various embodiments may also be resistant to such acids, bases, and chemicals. Without wishing to be bound by theory, the SiOC layer on the surface of the coal-based aggregate may function in the same way as the silicate layer on conventional rock and sand aggregates as well as most of the geomaterials and flyash used as synthetic aggregates.

The synthetic aggregate according to various embodiments comprises agglomerations and particles that may be significantly harder than most other aggregates and fillers, leading to improved compressive strength and abrasion resistance. Coal and its byproducts are very low cost (or are waste) priced at $0.01-$0.05 per pound, so the price of construction aggregates according to various embodiments could be comparable to other heavier (higher density) fillers which are in the ˜$0.30 to −$0.60 per pound range. Finally, significant infrastructure exists for the mining of coal and coal byproducts, but the use of such products to generate energy has fallen out of favor for environmental reasons. The synthetic aggregates according to various embodiments provide an environmentally-friendly alternate use for coal and coal byproducts, allowing the existing infrastructure to be used and potentially benefiting areas economically reliant on coal production.

Many applications exist for the high strength, low density, low cost synthetic aggregate according to various embodiments. The construction aggregate according to various embodiments may be useful to produce high Strength, low weight concrete; high strength, low weight, low water absorption cement-based pavers, siding, façade panels, roof tiles, and flooring; non-shrinking fillers for conventional ceramic roof tiles, pavers, floor tiles, bricks, ceramic ware. The synthetic aggregate according to various embodiments may be bonded using PDC resins to form coal core composite materials such as building components, support columns, face bricks, pavers, or façade panels. The synthetic aggregate according to various embodiments may be used as a low density, low cost performance enhancing filler in conventional thermoplastics such as polypropylene, polyethylene, or other polyolefins. The synthetic aggregate according to various embodiments may be used as a low cost, low density, performance enhancing filler for engineering plastics and high temperature resins due to its 400° C. temperature stability. The synthetic aggregate according to various embodiments may be used as a lightweight, abrasion resistant filler in metals such as aluminum, magnesium, zinc, and bronze.

### EXAMPLES

### Introduction

The following examples are put forth to provide those of ordinary skill in the art with a complete disclosure and description of how to perform the methods, how to make, and how to use the compositions and compounds disclosed and claimed herein. Efforts have been made to ensure accuracy with respect to numbers (e.g., amounts, temperature, etc.), but some errors and deviations should be accounted for. The purpose of the following examples is not to limit the scope of the various embodiments, but merely to provide examples illustrating specific embodiments.

### Example 1—Thermosetting SiOC Precursor and Bituminous Coal

A purpose of this example was to demonstrate production of a construction aggregate according to various embodiments.

Liquid SiOC Precursor A was mixed with a catalyst and a crosslinker in a 500 ml beaker to produce a total liquid mass of 300 grams. The mixture was stirred for 10 minutes to form a catalyzed liquid resin.

Precursor A, or “67/33,” is a mixture of 67% methylhydrogen siloxane (designated “MHF”) and 33% of dicyclopentadiene (designated “DCPD”).

The crosslinker is Tetravinyl-tetramethyl cyclotetrasiloxane (designated as “TVC”) added at 20 phr (20 parts crosslinker per 100 parts of resin). TVC is effective when used in a concentration of between 5 phr to 50 phr, but is expensive, so 10 to 20 phr is preferred.

The catalyst is Ashby's catalyst (any Platinum (Pt) catalyst may be used) diluted to 10 parts per million (ppm) Pt. and used at 1 phr concentration. The platinum catalyst was diluted with TVC down to 10 parts per million (ppm) and used in a range of 0.5 phr to 2 phr.

700 grams of bituminous coal powder with a particle size range of 1-10 micrometers was placed in a planetary mixer such as a KITCHEN-AID® mixer and the catalyzed liquid resin poured into the mixer while running on the “low” setting. The material was mixed for at least 15 minutes or until the powder was uniformly coated with the catalyzed liquid resin.

The resin-coated coal, having the consistency of damp sand was poured into a 6″×6″ steel mold and pressed to between 250 and 1000 psi (a load of 9000 to 36000 lbs) to form a plate.

The plate was cured by heating in air to 160° C. and held for 2 hours, then cooled. The plate is then heated at a rate of 2-5 degrees/per minute to 1000° C. in an inert gas atmosphere to convert the cured resin into an SiOC ceramic. The inert gas used was nitrogen, since it is the least expensive and is inert to the other materials below 1200° C. Argon and helium may also be used, but are more expensive (especially helium).

The composition for SiOC described as Si(x)C(y)O(z) with x+y+z=1 for these materials may range from Si(0.1)C(0.8)O(0.1) for high carbon materials to Si(0.4)C(0.1)O(0.5). The SiOC from Precusor A is in the Si(0.3)C(0.4)O(0.3) range.

The ceramic plate is then broken up with a hammer and the pieces fed into a “chain mill” pulverizer to convert the plate pieces to ceramic aggregate. The aggregate is sieved to size ranges of: −355 micrometers, +355/−600 micrometers, +600/−1.2 mm, and greater than 1.2 mm.

The synthetic aggregate was ready for use as a construction aggregate according to various embodiments.

### Example 2—Room Temperature Cure Resin with Fly-Ash

A purpose of this example was to demonstrate production of a construction aggregate according to various embodiments.

Liquid SiOC precursor B was mixed with a catalyst in a 500 ml beaker to produce a total liquid mass of 290 grams. The mixture is stirred for 10 minutes to produce a catalyzed liquid resin. Precursor B is 50% dimethyldisiloxane, 40% methyltrisiloxane and 10% tetraethylorthosilicate. The catalyst is dibutyltindilaurate added at a 2 phr level.

710 grams of fly ash powder with a particle size range of 5-45 micrometers was placed in a planetary mixer such as a KITCHEN-AID® mixer and the catalyzed liquid resin poured into the mixer while running on the “low” setting. The material was mixed for at least 15 minutes or until the powder is uniformly coated with the resin.

The coated fly ash was allowed to cure at room temperature for 48 hours and then the coated fly ash was placed onto a Teflon-coated steel tray and distributed such that the material makes a roughly ½ to ⅝ inch thick layer. The layer is lightly tamped to consolidate the powder onto the tray.

The material was cured by heating in air to 160° C. and held for 2 hours, then cooled, and placed into a stainless steel tray. The tray with the cured material was then heated at a rate of 2-5 degrees/per minute to 1000° C. in an inert gas (nitrogen) atmosphere to convert the cured resin into an SiOC ceramic. In this case a low carbon ceramic in the range of Si(0.45)C(0.1)O(0.45) was produced.

The ceramic material was then broken up with a hammer and the pieces fed into a “chain mill” pulverizer to convert the plate pieces to ceramic aggregate. The aggregate was sieved to size ranges of: −355 micrometers, +355/−600 micrometers, +600/−1.2 mm, and greater than 1.2 mm.

The synthetic fly ash aggregate was ready for use as a construction aggregate according to various embodiments.

### Example 3—Lignite Clay-Based Aggregate

A purpose of this example was to demonstrate production of a construction aggregate according to various embodiments.

Liquid SiOC precursor C was mixed with a catalyst and a crosslinker in a 1000 ml polypropylene beaker to produce a total liquid mass of 300 grams. The mixture was stirred for 10 minutes to produce a resin mix. Precursor C is made from 55% methylhydrogensiloxane and 45% dicyclopentadiene. The catalyst in this case is a peroxide called Luperox 351 which is a liquid peroxide with a 10 hour half life of 93° C. other peroxides with higher temperature half lives such as Luperox 101 or dicumyl peroxide have been used. The peroxide is added at 2 phr in this case, but peroxides are effective for these materials in the 0.5 phr range up to 4 phr. In this case the crosslinker was divinylbenzene (designated “DVB”) and it was added at 10 phr. DVB is a very active crosslinker and can be added at a level of 1 phr up to 30 phr depending on the resin used.

15 grams of a surfactant such as Silube T310-A-16, Gransurf 61, or Triton TX100 were then added to the resin mix and stirred vigorously for 15 minutes. The Silube T310-A-16 in this case, however the other two have also been demonstrated to work.

135 grams of distilled water is then slowly added to the resin mix while stirring at high speed (1500-3000 rpm) using a high shear mixing blade. Once all the water is added, the resulting emulsion was stirred at the same speed for 5-10 minutes.

Once the emulsion was made, 700 grams of lignite coal powder with a particle size range of 1-10 micrometers was placed in a planetary mixer such as a KITCHEN-AID® mixer and the catalyzed resin/water emulsion was poured into the mixer while running on the “low” setting to produce a lignite “clay.” This material was mixed for at least 15 minutes or until the material starts to behave like bread dough or clay in the mixer.

Once the lignite “clay” was made, it was then de-aired and extruded through a clay extruder to produce 4 inch diameter rods of dense clay. The rods were sliced into 1 inch thick disks or are slit lengthwise into 4 triangular strips and placed on a stainless steel tray for drying and curing. The clay was dried and cured by heating in flowing air to 90° C. to 95° C. and holding for 6-8 hours to evaporate off the water. Then the parts were heated to 175° C. for 4 hours to cure the resin.

The cured clay pieces were then heated at a rate of 2-5 degrees/per minute to 1000° C. in an inert gas atmosphere to convert the cured resin into an SiOC ceramic.

The ceramic pieces were then broken up with a hammer and the pieces fed into a “chain mill” pulverizer to convert the plate pieces to ceramic aggregate. The aggregate was sieved to size ranges of: −355 micrometers, +355/−600 micrometers, +600/−1.2 mm, and greater than 1.2 mm.

The synthetic aggregate was ready for use as a construction aggregate according to various embodiments.

### Example 4—Concrete Comprising a Construction Aggregate

A purpose of this example was to demonstrate use of a construction aggregate according to various embodiments in a concrete according to various embodiments.

The batch of concrete containing the synthetic aggregate was produced as an aggregate composition of 70% bituminous coal, initial particle size of 1-10 micrometers with the average size ˜7 micrometers prior to mixing with 30% of SiOC Polymer “A” and then cured and pyrolyzed to form the ceramic coated coal synthetic aggregate. The materials used to produce the concrete was based on a formula to make approximately 625 grams of concrete: 222 grams of standard Portland cement; 95 grams of water; 56 grams of milled aggregate size<10 micrometer particle size; 245 grams of Fine aggregate of −500 micrometer particle size; and 7 grams of standard cement plasticizer.

All components were mixed in 1 liter polypropylene beaker using a 1.5 inch diameter, 4-bladed mechanical stirrer shaft running at 500 rpm for 20 minutes. The material was like a stiff clay that was packed into a 4″×6″ mold and allowed to cure. Additionally, some of the material was poured into a 3 inch long, 1.5″ diameter polyvinyl chloride (Standard “PVC” pipe) with a PVC cap on one end and allowed to cure. The plate was removed from the mold after one day and allowed to air cure at room temperature for 7 days it will then be cut into flexure bars for flexure strength testing, the rod would be removed from the PVC mold after one day and allowed to air cure at room temperature for 28 days and then the density was calculated (simply as mass of the cylinder/volume of cylinder) then it was compression tested to produce the data in the table. This batch of concrete had a density of 1.65 grams/cc and a compressive strength of 7,500 psi after full curing of 28 days. Other concretes made by this process ranged in density from 1.3 grams/cc and 2,000 psi and 1.5 grams/cc and a compressive strength of 4,500 psi.

This synthetic aggregate has been shown to be suitable for concrete made with Portland cement, Pozzolan-lime cements, Slag-lime cements, Calcium sulfoaluminate cements, magnesium cements among others.

It was unexpectedly found that there is sufficient bonding between the aggregate and Portland cement during curing of the cement. This is important for developing a high strength concrete. The finding is somewhat unexpected as typically coal cannot be used in water based systems such as concrete since the coal cannot be easily wet by water and therefore won't bond to cement or other water-based adhesive or structural materials. Without wishing to be bound by theory, the SiOC ceramic coating on the coal in the aggregate may provide a silica type surface similar to the silica/silicate surfaces found in sand and standard aggregate. As a result, the cement will bond to the coal/ceramic aggregate, according to various embodiments, as well as it does to conventional aggregates. The coal ceramic aggregate, however, is much lower in density and can be stronger and harder than conventional aggregates, thereby imparting improved strength and wear resistance.

The density of the concrete produced had a density of 1.65 g/cc In this case, since the concrete produced was a uniform cylinder with a flat top and bottom, its density was calculated by measuring the mass of the cylinder and dividing it by the calculated volume of the cylinder.

However, the density can range from 1.3 grams/cc to about 1.95 depending on the percentage of coal in the aggregate and the ratio of aggregate to cement. Also, the particle size of the aggregate and particle size ratio between the coarse aggregate and the fine aggregate can be used to control the porosity of the concrete and therefore also the strength and density. For example: using a mixture of 20% coarse aggregate (particle size range: +600/−1000 micrometers) and 80%-355 micrometers (composed of 70% bituminous coal with 30% SiOC polymer A) and using the same cement and water ratio, resulted in a material with a density of 1.41 grams/cc and a compressive strength of only 2,500 psi. Standard mineral/rock/sand based aggregates typically range in density from 2.4-2.7 grams/cc and/or metal fibers (density 7.8 grams/cc) are sometimes used to produce ultra-high strength concrete, these also affect the density of the concrete.

Table 1 shows a comparison of commercially available concretes and concrete made with the carbon/ceramic aggregate.

TABLE 1
Concrete Properties

| | | Compressive | Cost per | Cost | Specific |
|---|---|---|---|---|---|
| | Density | Strength | cubic meter | per psi | Strength |
| | (g/cc) | (psi) | ($) | ($/psi) | (psi/density) |
| Standard | 2.5 | 3,000 | $100 | $0.033 | 1200 |
| Concrete | | | | | |
| UHPC | 2.5 | 17,000 | $1000 | $0.059 | 6800 |
| Agg | 1.65 | 7,500 | <$700 | $0.053 | 4545 |
| Concrete | | | | | |
| from | | | | | |
| Example 4 | | | | | |

This aggregate has also been shown to be compatible with other concrete additives such as silica fume and chemical plasticizers and water reducers.

High strength concrete was produced by adding extra ingredients to the mix which may be silica fume, water reducers, quartz flower, and metallic fibers. The simple concrete mixture described in Example 4 was produced using the carbon/ceramic aggregate that has a 28 day compressive strength of 7,500 psi. Table 2 lists the ingredients for a potential cubic meter of concrete based on the material described in Example 4.

TABLE 2
Carbon/Ceramic Concrete Mix

| Ingredients | Quantity (kg/m\hat{ }3) |
|---|---|
| Portland Cement | 955 |
| Coarse Carbon/Ceramic Aggregate | 1051 |
| (500 to 1000 μm) | |
| Coarse Carbon/Ceramic Aggregate | 239 |
| (<500 μm) | |
| Water | 162 |
| Superplastisizer | 15 |

### Example 5

A purpose of this example was to demonstrate ceramic bricks (X-BRIX) using Coal/Ceramic aggregate.

An X-BRIX Coal/ceramic based brick can be made from either “as-cured coal/PDC precursor aggregate or fully fired ceramic coated coal based aggregate. This example is for using ceramic coated coal aggregate to make a cylinder for compression testing

50 grams of coal/ceramic aggregate (made from 70% bituminous coal and 30% SiOC polymer A (from Example 1) was sieved a particle size range of +800/−1050 micrometers and poured into a 500 ml polypropylene beaker, separately, 12 grams of aggregate from Example 1 that was sieved to a particle size of −325 was mixed in a small plastic cup with 35 grams of SiOC Polymer A using a spatula until the fine ceramic aggregate was uniformly dispersed. The very fluid black mixture was then poured into the 500 ml beaker containing the 50 grams of coarse coal/ceramic aggregate and the material mixed with a spatula until all of the larger aggregate was uniformly coated and the consistency was that of wet sand. The material was then transferred using a spoon to a 1 inch inner diameter steel die mold to a depth of approximately 2.5 inches. The mixture was carefully and evenly loaded into the mold and tamped lightly with a 1″ diameter wooden dowel. The cylinder was pressed to 250 psi for 5 minutes and then resulting rod pushed out of the mold. The rod was placed in a convection oven and heated to 110° C. for 2 hours, followed by heating to 120° C. for 2 hours. The cured rod was then pyrolyzed by heating in nitrogen to 1000° C. at 2° C./minute with a 4 hour hold at 500° C. The pyrolysis converts the polymer to ceramic, to form a coal/ceramic aggregate based ceramic rod for compression testing

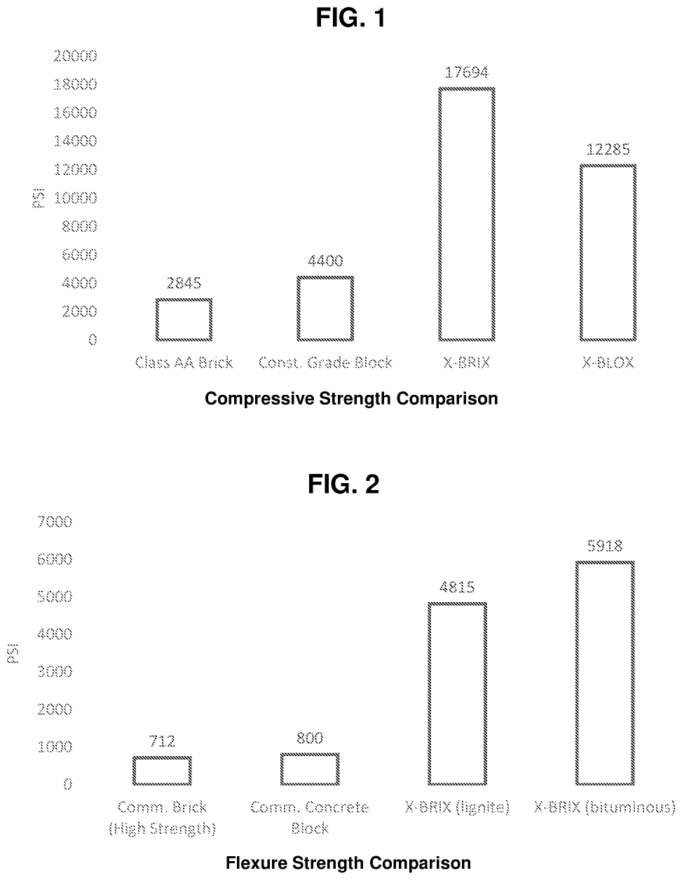

FIG. 1 is an example according to various embodiments, illustrating the compressive strength of bricks and blocks comprising construction aggregates according to various embodiments in comparison to conventional bricks and blocks.

### Example 6

A purpose of this example was to demonstrate that an X-BLOX Coal/ceramic based Block can be made from either “as-cured coal/PDC precursor aggregate or fully fired ceramic coated coal based aggregate. This example is for using ceramic coated coal aggregate to make a plate for flexure testing

50 grams of coal/ceramic aggregate (made from 70% bituminous coal and 30% SiOC polymer A (from Example 1) was sieved a particle size range of +800/−1050 micrometers and poured into a 500 ml polypropylene beaker, separately, 11 grams of aggregate from Example 1 that was sieved to a particle size of −325 was mixed in a small plastic cup with 32 grams of SiOC Polymer A using a spatula until the fine ceramic aggregate was uniformly dispersed. The very fluid black mixture was then poured into the 500 ml beaker containing the 50 grams of coarse coal/ceramic aggregate and the material mixed with a spatula until all of the larger aggregate was uniformly coated and the consistency was that of wet sand. The material was spooned into a 3″×5″ steel mold and distributed uniformly to fill the mold ⅔ full. The material was pressed in the mold with a pressure of 350 psi for 5 minutes, then the pressure was released, the plate was placed in a convection oven and heated to 110° C. for 2 hours, followed by heating to 120° C. for 2 hours. The cured rod was then pyrolyzed by heating in nitrogen to 1000° C. at 2° C./minute with a 4 hour hold at 500° C. The pyrolysis converts the polymer to ceramic, and the resulting coal/ceramic aggregate based ceramic X-BLOX type plate was cut into flexure bars and flexure tested after its density was calculated.

FIG. 2 is an example according to various embodiments, illustrating the flexure strength of bricks and blocks comprising construction aggregates according to various embodiments in comparison to conventional bricks and blocks.

### Example 7

The densities of the X-BRIX and X-BLOX were taken from the cylinder in Example 5 and the plate in Example 6.

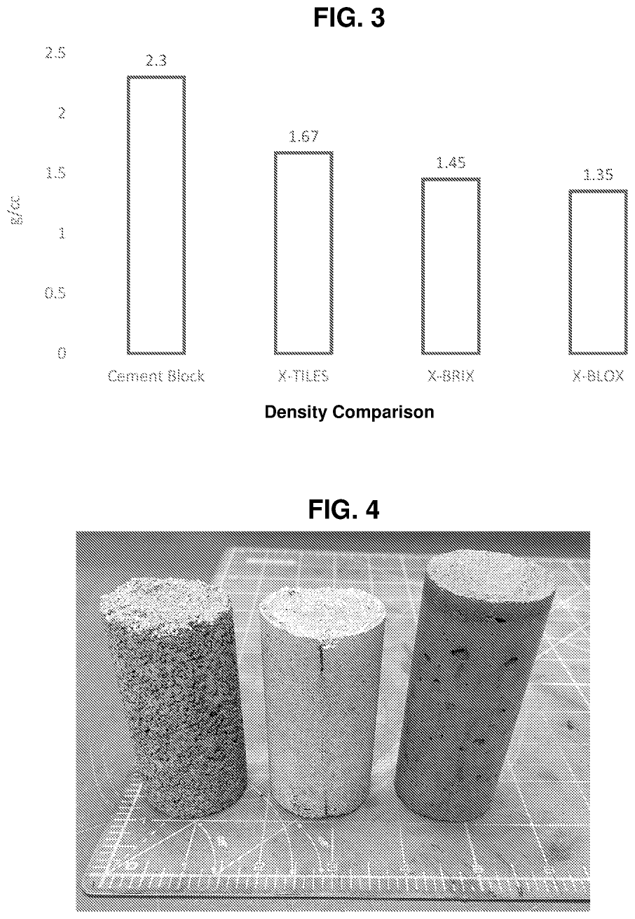

FIG. 3 is an example according to various embodiments, illustrating the density of tiles, bricks, and blocks comprising construction aggregates according to various embodiments in comparison to conventional bricks and blocks.

### Example 8

FIG. 4 is an example according to various embodiments, illustrating three concrete cylinders comprising construction aggregates according to various embodiments.

What is claimed is:

1. A synthetic aggregate comprising:
a plurality of agglomerations, each of the plurality of agglomerations comprising:
a core; and
a shell material disposed on the core,
wherein the core comprises one selected from the group consisting of coal, a coal byproduct, and combinations thereof,
wherein the shell material comprises a polymer-derived ceramic material,
wherein the plurality of agglomerations has an average size of from about 0.1 micrometers to about 5 millimeters,
wherein the construction aggregate has a density of from about 1.57 g/cc to about 1.95 g/cc.

2. The synthetic aggregate according to claim 1, wherein at least one of the plurality of agglomerations comprises a plurality of cores.

3. The synthetic aggregate according to any of claims 1-2, wherein the core comprises coal, and wherein the coal is a type selected from the group consisting of lignite, sub-bituminous, bituminous, and anthracite.

4. The synthetic aggregate according to any of claims 1-3, wherein the core comprises the coal byproduct, and wherein the coal byproduct is one selected from the group consisting of fly ash, bottom ash, shale coal, and coal gob.

5. The synthetic aggregate according to any of claims 1-4, wherein the core material represents up to 70% by weight of the construction aggregate, and wherein the construction aggregate is not flammable.

6. The synthetic aggregate according to any of claims 1-5, wherein the polymer-derived ceramic material is derived from a precursor selected from the group consisting of silicon oxycarbide (SiOC), silicon carbide (SiC), silicon nitride (Si₃N₄); and silicon carbonitride (SiCN).

7. The synthetic aggregate according to claim 6, wherein the silicon oxycarbide is a high-oxygen silicon carbide (SiCO), comprising at least 20% oxygen by weight.

8. A concrete comprising a first synthetic aggregate and optionally a second synthetic aggregate according to claim 1, wherein the first synthetic aggregate and the second synthetic aggregate differ at least in the average particle size of the plurality of agglomerations contained therein.

9. The concrete according to claim 8, wherein the concrete comprises both the first synthetic aggregate and the second synthetic aggregate,
wherein the plurality of agglomerations of the first synthetic aggregate has an average size of from about 500 to about 100 micrometers, and
wherein the plurality of agglomerations of the second synthetic aggregate has an average size less than about 500 micrometers.

10. The concrete according to any of claims 8-9, wherein the concrete exhibits a compressive strength of from about 3000 to about 7500 psi.

11. The concrete according to any of claims 8-10, wherein the concrete exhibits a flexural strength of from about 500 psi to about 2000 psi.

12. The concrete according to any of claims 8-11, wherein the concrete exhibits a density of from about 1.3 g/cc to about 2.4 g/cc.

13. The concrete according to any of claims 8-12, wherein the concrete comprises from about 50% to about 85% by weight of the first synthetic aggregate.

14. The concrete according to any of claims 8-13, wherein the concrete comprises from about 15% to about 50% by weight of the second synthetic aggregate.

15. The concrete according to any of claims 8-14, wherein the concrete comprises from about 30% to about 60% by weight of cementious material

16. A method comprising:
mixing a plurality of core material particles with a polymer-derived ceramic precursor material and optionally a catalyst to form a mixture,
wherein each of the plurality of core material particles comprise one selected from the group consisting of coal, a coal byproduct, and combinations thereof;
heating the mixture to a curing temperature for a curing time to form a cured mixture;
pyrolyzing the cured mixture in the presence of an inert gas at a pyrolysis temperature of from about 700 degrees Celsius to about 1200 degrees Celsius for a pyrolysis time of from about 3 to about 5 hours to produce a plurality of agglomerations,
wherein each of the plurality of agglomerations comprise:
a core; and
a shell material disposed on the core,
wherein the core comprises at least one core material particle,
wherein the shell material comprises a polymer-derived ceramic material derived from the polymer-derived ceramic precursor material,
milling and sieving the plurality of agglomerations to have an average size of from about 0.1 micrometers to about 5 millimeters to produce a construction aggregate,
wherein the construction aggregate has a density of from about 1.57 g/cc to about 1.95 g/cc.

17. The method according to claim 16, further comprising mixing the construction aggregate with a cement to form a concrete.

18. The method according to any of claims 16-17, wherein the coal is a type selected from the group consisting of lignite, sub-bituminous, bituminous, and anthracite.

19. The method according to any of claims 16-18, wherein the coal byproduct is one selected from the group consisting of fly ash, bottom ash, shale coal, and coal gob.

20. The method according to any of claims 16-19, wherein the curing temperature is from about 20 degrees Celsius to about 200 degrees Celsius and wherein the curing time is from about 1 to about 3 hours to form a cured mixture.
